(19) United States
(12) Patent Application Publication
(10) Pub. No.: US 2017/0340419 A1
(43) Pub. Date: Nov. 30, 2017

(54) TOOTH TYPE JUDGMENT PROGRAM, TOOTH TYPE POSITION JUDGMENT DEVICE AND METHOD OF THE SAME

(71) Applicant: FUJITSU LIMITED, Kawasaki-shi (JP)

(72) Inventors: Ryosuke OHTAKE, Atsugi (JP); Katsumi UMEKAWA, Yokohama (JP); TATSUKIYO ISHIMURA, Kawasaki (JP)

(73) Assignee: FUJITSU LIMITED, Kawasaki-shi (JP)

(21) Appl. No.: 15/606,885

(22) Filed: May 26, 2017

(30) Foreign Application Priority Data
May 30, 2016 (JP) 2016-107358

(51) Int. Cl. A61C 13/00; G06F 19/00; A61C 9/00; G06K 9/52; A61C 5/77

(52) U.S. Cl. CPC A61C 13/0004; G06K 9/52; A61C 5/77; A61C 9/0053; G06F 19/3437

(57) ABSTRACT

The tooth type judgment program includes, extracting point groups indicating a surface of three-dimensional profile data from inputted three-dimensional profile data; moving and/or rotating the three-dimensional profile data of a tooth corresponding to a specific type of tooth; calculating an arrangement relationship in which an error between a point group included in any of a region of the extracted point groups and the three-dimensional profile data of the tooth becomes minimum, and estimating a direction of the tooth included in the region based on the calculated arrangement relationship.

### CROSS-REFERENCE TO RELATED APPLICATION

This application is based upon and claims the benefit of priority of the prior Japanese Patent Application No. 2016-107358, filed on May 30, 2016, the entire contents of which are incorporated herein by reference.

### FIELD

The present invention relates to a tooth type judgement program, crown position judgment device and a method of the same.

### BACKGROUND

It is known to use tooth type data indicating a tooth profile including the shape of a crown of teeth. For example, it is known to fabricate dental crown prostheses such as crowns and bridges by NC processing from processing data created based on crown profile data selected from a database (see, for example, Patent Literature 1). It is also known to obtain tooth contour information from an unspecified number of survivors in order to identify the identity of unidentified persons caused by disasters, unexpected accidents, etc., and store the tooth contour information in a pre-living database (See, for example, Patent Literature 2).

Further, various techniques of creating oral cavity profile data including crown profile data are known. For example, it is known that by a user assisting a computer to recognize individual teeth by providing input data specifying one or more points on a tooth raw surface, gingival margin data is easily created by the computer (see, for example, Patent Literature 3).

### RELATED DOCUMENTS

[Patent Document 1] Japanese Laid Open Patent Document No. H9-10231
[Patent Document 2] Japanese Laid Open Patent Document No. 2009-50632
[Patent Document 3] Japanese Laid Open Patent Document No. 2014-512891

### SUMMARY

According to an aspect, the tooth type judgment program includes, extracting three-dimensional point groups having normal vectors indicating a surface of three-dimensional profile data, from the inputted three-dimensional profile data, extracting point groups included in any of an analysis target regions of the extracted three-dimensional point groups having normal vectors s, calculating a local coordinate system, based on a normal vectors variance of the extracted point groups included in the analysis target region, obtaining a unit normal vector distribution in the local coordinate system, corresponding to each point of the point groups included in the analysis target region, and referring to a storage unit that stores distribution information regarding a direction of the unit normal vectors in the local coordinate system, corresponding to each point of the point groups in association with a tooth type, and estimating the tooth type corresponding to the obtained distribution as the tooth type in the analysis target region.

The object and advantages of the embodiments will be realized and attained by means of the elements and combination particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a tooth type judgment device according to an embodiment;

FIG. 2 is a flowchart of the tooth type judgment processing performed by the tooth type judgment device illustrated in FIG. 1;

FIG. 3 is a perspective view of a tooth;

FIG. 4A is a view illustrating an example of a 3D surface mesh included in crown data;

FIG. 4B is a view illustrating 3D point groups corresponding to the 3D surface mesh illustrated in FIG. 5A;

FIG. 5 is a view illustrating an example of the feature points extracted by the vertex extraction unit illustrated in FIG. 1;

FIG. 6 is a view illustrating an example of processing of calculating the normal vector of the feature points;

FIG. 7 is a view illustrating an example of the normal vectors of the feature points calculated in the process of S103 illustrated in FIG. 2;

FIG. 8 is a view illustrating an example of the local coordinate system calculated in the process of S104 illustrated in FIG. 2;

FIG. 9 is a histogram illustrating the directions of the normal vectors of the feature points converted to the polar coordinates system in the process of S105 illustrated in FIG. 2;

FIG. 10A is a view illustrating an example of the two-dimensional histogram;

FIG. 10B is a view illustrating another example of the two-dimensional histogram;

FIG. 11 is a flowchart illustrating more detailed processing than the process of S104 illustrated in FIG. 2;

FIG. 12A is a view illustrating an example of the X axis defined in the SHOT descriptor;

FIG. 12B is a view illustrating an example of the X axis defined for the crown;

FIG. 13 is a view illustrating an example of the X axis and the second axis calculating axis N defined for the crown;

FIG. 14 is a view illustrating an example of the X axis, the second axis calculating axis N and the Y axis defined for the crown; and

FIG. 15 is a view illustrating an example of the X axis, the second axis calculating axis N, the Y axis and the Z axis defined for the crown;

### DESCRIPTION OF EMBODIMENTS

A crown position judgment device will be described hereafter, with reference to the drawings. The crown position judgment device estimates the position of the crown corresponding to the crown data from the distribution of in the direction of the normal vector of vertices in the local coordinate system determined from the distribution in the direction of the normal vector of vertices extracted from the crown data indicating the shape of the crown. The crown position judgment device can estimate the position of the tooth raw of the tooth corresponding to the crown, with no need to designate the point on the surface of the tooth row by a user, using the distribution in the direction of the normal vector of vertices in the local coordinate system.

### (A Configuration and a Function of the Tooth Type Judgment Device According to an Embodiment)

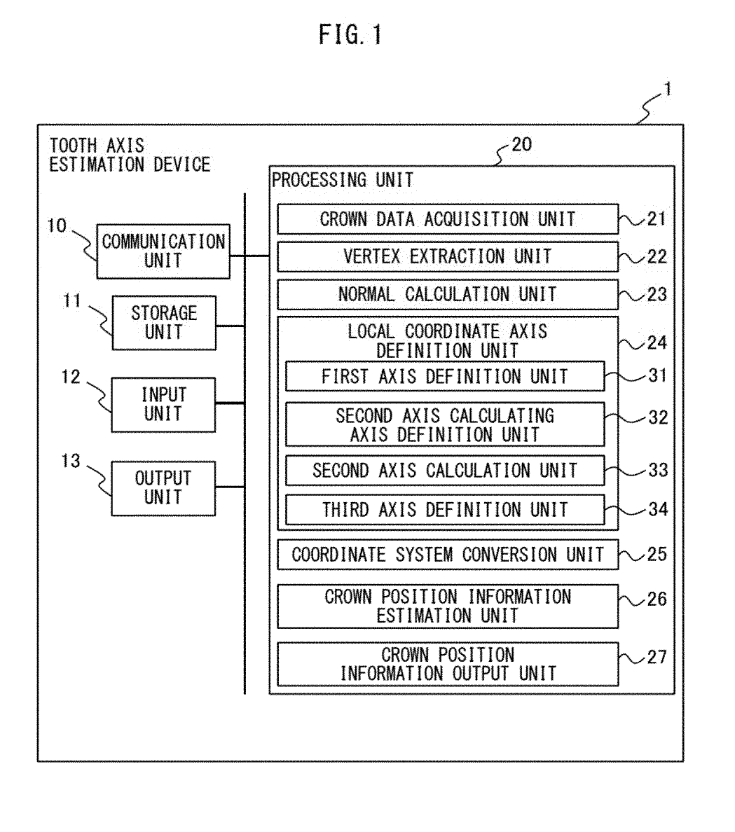

FIG. 1 is a block diagram of a tooth type judgment device according to an embodiment.

A tooth type judgment device 1 includes a communication unit 10, a storage unit 11, an input unit 12, an output unit 13, and a processing unit 20.

The communication unit 10 communicates with a server (not illustrated) and the like via the Internet according to a protocol of HTTP (Hypertext Transfer Protocol). Then, the communication unit 10 supplies data received from the server or the like to the processing unit 20. Further, the communication unit 10 transmits the data supplied from the processing unit 20 to the server or the like.

The storage unit 11 includes, for example, at least one of a semiconductor device, a magnetic tape device, a magnetic disk device, or an optical disk device. The storage unit 11 stores an operating system program, a driver program, an application program, data, and the like used for processing in the processing unit 20. For example, the storage unit 11 stores a tooth type judgment program as an application program for causing the processing unit 20 to execute tooth type judgment processing for judging tooth type. The tooth type judgment program and the tooth profile data creation program may be installed in the storage unit 11 from a computer-readable portable recording medium such as a CD-ROM, a DVD-ROM or the like using a known setup program or the like.

In addition, the storage unit 11 stores, as data, data or the like to be used in input processing and the like. Further, the storage unit 11 may temporarily store data temporarily used in processing such as input processing. For example, the storage unit 11 stores distribution information on the direction of the unit normal vector corresponding to each point of the point groups in the local coordinate system by associating the distribution information with the type of the tooth. As an example, the distribution information stored in the storage unit 11 is the two-dimensional histogram.

The input unit 12 may be any device as long as data can be inputted, and may be a touch panel, a key button, or the like for example. An operator can input letters, numbers, symbols, and the like using the input unit 12. When operated by an operator, the input unit 12 generates a signal corresponding to the operation. Then, the generated signal is supplied to the processing unit 20 as an instruction of the operator.

The output unit 13 may be any device as long as it can display images, frames, and the like, for example, and is a liquid crystal display or an organic EL (Electro-Luminescence) display or the like. The output unit 13 displays images corresponding to image data supplied from the processing unit 20, and frames or the like corresponding to moving image data. Further, the output unit 13 may be an output device for allowing images, frames, letters or the like to be printed on the display media such as papers.

The processing unit 20 has one or more processors and peripheral circuits thereof. The processing unit 20 comprehensively controls an overall operation of the tooth type judgment device 1 and may be, for example, the CPU. The processing unit 20 executes processing based on a program (driver program, operating system program, application program, etc.) stored in the storage unit 11. Further, the processing unit 20 can execute programs (application programs, etc.) in parallel.

The processing unit 20 includes a crown data acquisition unit 21, a vertex extraction unit 22, a normal vector calculation unit 23, a local coordinate axis definition unit 24, a coordinate system conversion unit 25, a crown position information estimation unit 26 and a crown position information output unit 27. The local coordinate axis definition unit 24 has a first axis definition unit 31, a second axis calculating axis definition unit 32, a second axis calculation unit 33, and a third axis definition unit 34. Each of these units is a functional module realized by a program executed by a processor included in the processing unit 20. Alternatively, each of these units may be mounted on the tooth type judgment device 1 as firmware.

### (Operation of the Tooth Type Judgment Device According to an Embodiment)

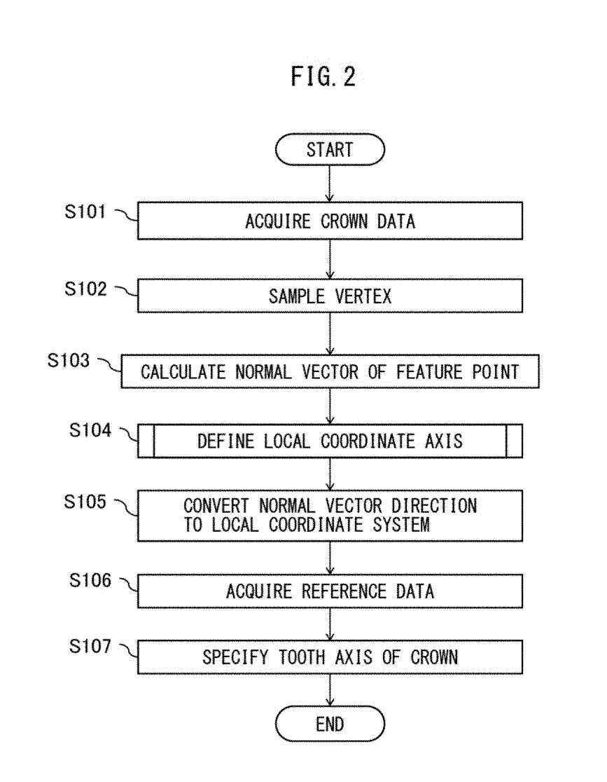

FIG. 2 is a flowchart of the tooth type judgment processing performed by the tooth type judgment device 1. The tooth type judgment processing illustrated in FIG. 2 is executed mainly by the processing unit 20 in cooperation with each element of the tooth type judgment device 1, based on a program stored in the storage unit 11 in advance.

The process of S101 includes a process of extracting point groups indicating the surface of the three-dimensional profile data, from the inputted three-dimensional profile data. The processes of S102 to S107 includes processes of moving and/or rotating the three-dimensional profile data of a tooth corresponding to a specific type of tooth, calculating an arrangement relationship in which an error between a point group included in any of a region of the extracted point groups and three-dimensional profile data of a tooth becomes minimum, and estimating a direction of the tooth included in this region based on the calculated arrangement relationship. Here, the analysis target region is set in a region within a predetermined range from a target part for specifying the type of the tooth.

First, the crown data acquisition unit 21 acquires crown data indicating the shape of the crown including vertices (S101).

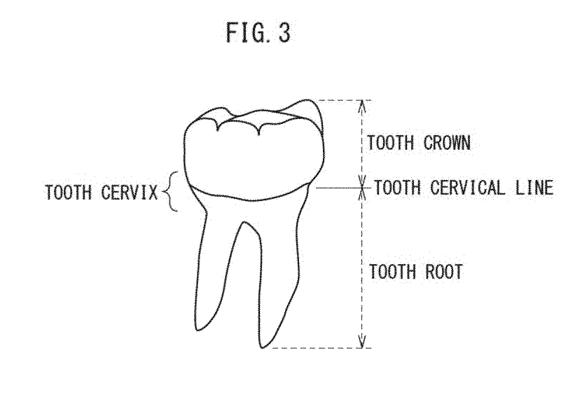

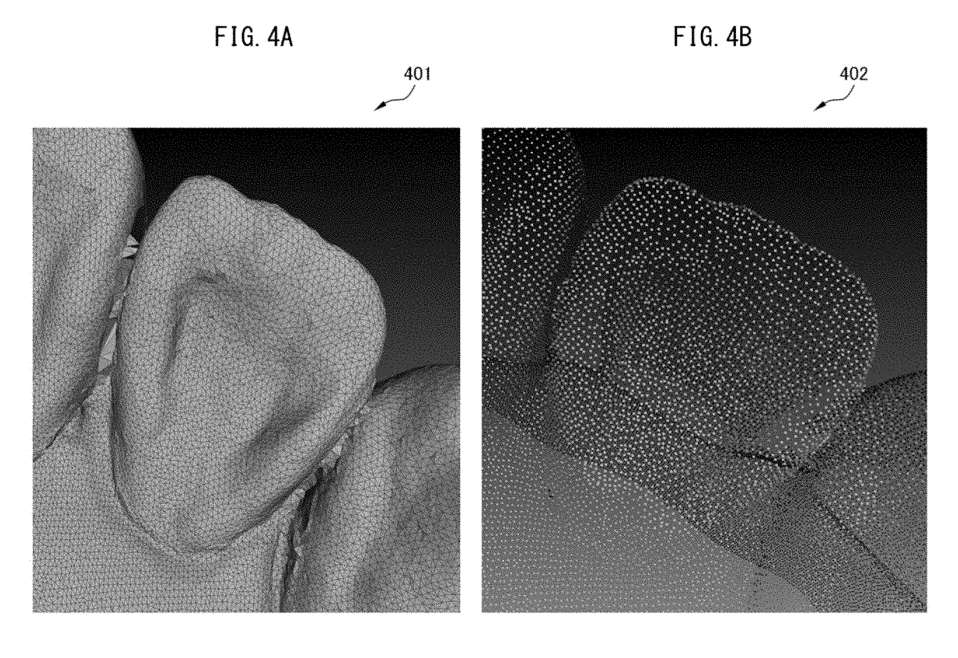

FIG. 3 is a perspective view of a tooth, FIG. 4A is a view illustrating an example of a 3D surface mesh included in crown data, and FIG. 4B is a view illustrating 3D point groups corresponding to the 3D surface mesh illustrated in FIG. 4A.

The crown is a portion of the entire teeth, appears to the outside from a gingiva, is exposed (erupted) into an oral cavity, and is covered with enamel. A part below the crown is called a “tooth root” and a boundary line between the crown and tooth root is called a “tooth cervical line”.

Tooth type scan data 401 is acquired by use of a dental 3D scanner (not illustrated), as tooth type information of each of an unspecified majority. As an example, the tooth type scan data 401 is acquired as dental CAD (Computer Aided Design)/CAM (Computer Aided Manufacturing) data at dental laboratories, dental clinics and the like. The tooth type scan data 401 is stored in the storage unit 11 in a file format such as stl, ply, off, and 3 ds, etc. The tooth type scan data 401 is an aggregate of triangular polygons. The 3D point group data 402 includes vertices corresponding to the vertices of the triangular polygon included in the tooth type scan data 401.

Next, the vertex extraction unit 22 uniformly, i.e., evenly samples the vertices included in an analysis target region of the tooth type scan data from an entire region of the aggregate (S102). As an example, the vertex extraction unit 22 samples about 200 thousand to 600 thousand vertices included in the analysis target region of the tooth type scan data and extracts about 10 thousand feature points. The analysis target region is set in a region within a predetermined range from a target part for specifying the type of the tooth.

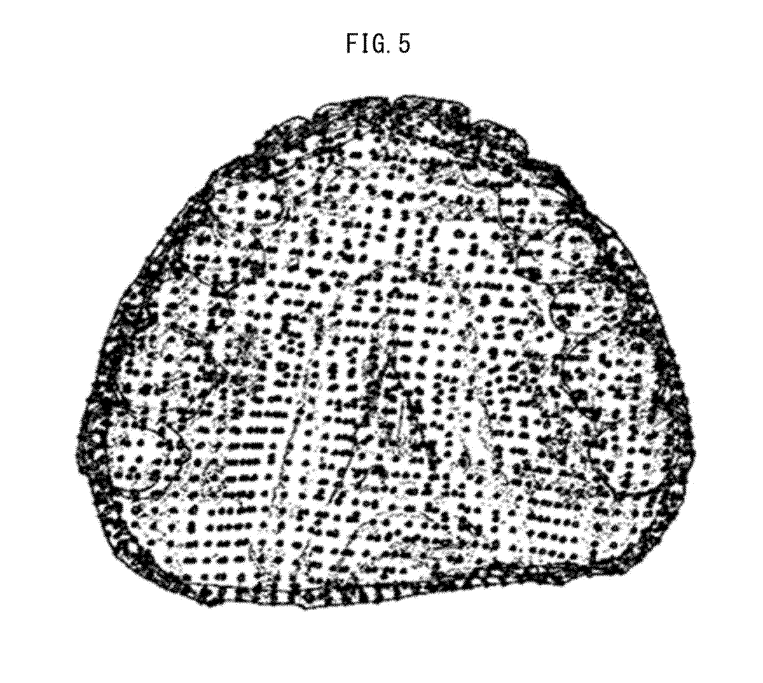

FIG. 5 is a view illustrating an example of the feature points extracted by the vertex extraction unit 22. In FIG. 5, the feature points are indicated by black spots.

Next, the normal vector calculation unit 23 calculates a normal vector of the feature points extracted by the process of S102 (S103). The normal vector calculation unit 23 calculates the normal vector of the feature points, by weighting the directions of the normal vector of triangular polygons including a feature point, according to areas of the polygons. In other words, the local coordinate axis definition unit 24 calculates the local coordinate system based on the normal vectors variance of the point groups included in the extracted analysis target area.

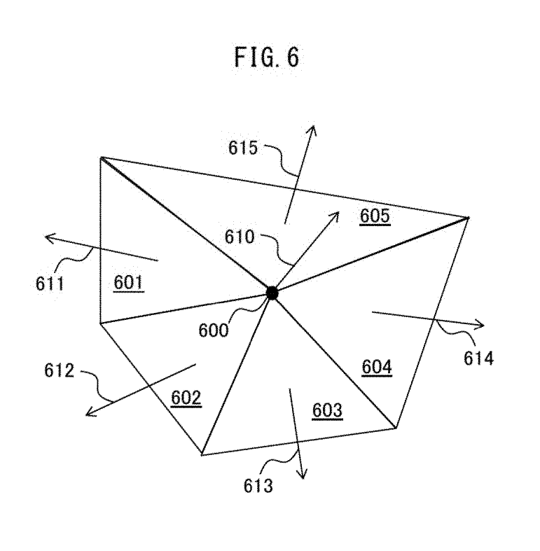

FIG. 6 is a view illustrating an example of processing of calculating the normal vector of the feature points.

Feature points 600 are vertices of five polygons, i.e., a first polygon 601, a second polygon 602, a third polygon 603, a fourth polygon 604, and a fifth polygon 605. A first normal vector 611 is the normal vector of a first polygon 601, a second normal vector 612 is the normal vector of a second polygon 602, and a third normal vector 613 is the normal vector of a third polygon 603. Further, a fourth normal vector 614 is the normal vector of a fourth polygon 604, and a fifth normal vector 615 is the normal vector of a fifth polygon 605. The first normal vector 611, the second normal vector 612, the third normal vector 613, the fourth normal vector 614, and the fifth normal vector 615 have the same unit lengths.

The normal vector calculation unit 23 calculates the direction of the normal vector 610 of the feature point 600 by weighting each of the first normal vector 611 to the fifth normal vector 615 with each of the areas of the first polygon 601 to the fifth polygon 605. The normal vector 610 of the feature point 600 has the unit length as with the first normal vector 611 to the fifth normal vector 615. In other words, the coordinate system conversion unit 25 obtains the unit normal vector distribution corresponding to each point of the point groups included in the analysis target area in the local coordinate system.

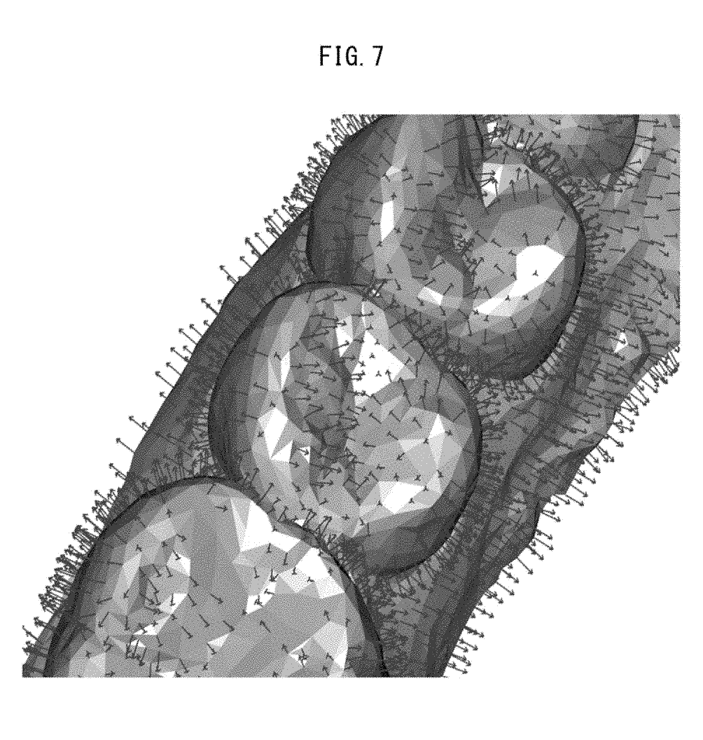

FIG. 7 is a view illustrating an example of the normal vectors of the feature points calculated in the process of S103. The normal vectors of the feature points are calculated in the process of S103, i.e., the directions of the normal vectors of the triangular polygons including a feature point are weighted according to the areas of the polygons for calculation, and all of the normal vectors have the same unit lengths.

Next, for each of the feature points, the local coordinate axis definition unit 24 defines a local coordinate axis based on the distribution in the direction of the normal vector calculated in the process of S103 (S104). In other words, the local coordinate axis definition unit 24 calculates a local coordinate system, based on a normal vectors variance of the extracted point groups included in the analysis target region.

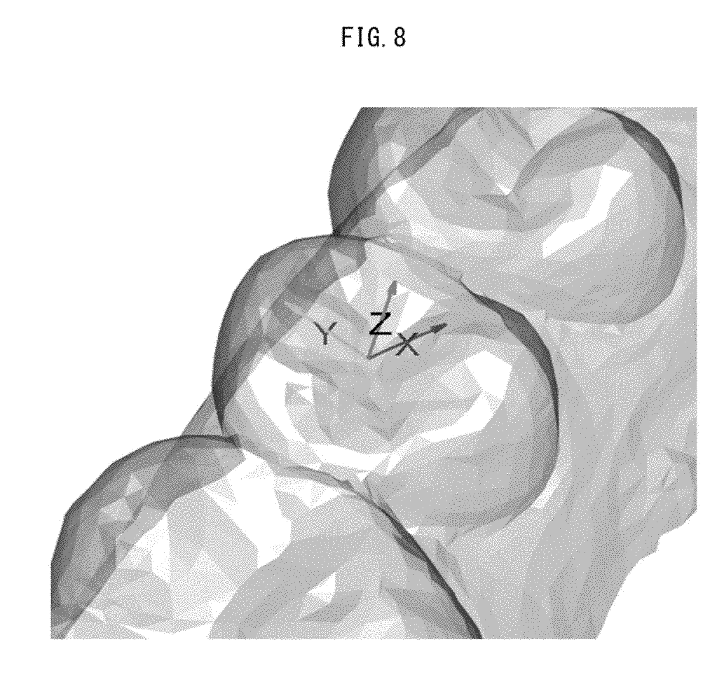

FIG. 8 is a view illustrating an example of the local coordinate system (Local Reference Frame, LRF) calculated in the process of S104.

In the local coordinate system, X direction is defined as a direction in which the distribution in the direction of the normal vector calculated in the process of S103 is most varied, in other words, the direction in which the variance is the largest. Further, Y direction is a direction orthogonal to the X direction, and Z direction is a direction orthogonal to both the X direction and the Y direction.

Next, the coordinate system conversion unit 25 converts the directions of the normal vectors of the feature points calculated in the process of S103 for each of the feature points, to the local coordinate system calculated in the process of S104 (S105). In other words, the coordinate system conversion unit 25 obtains a unit normal vector distribution in the local coordinate system, corresponding to each point of the point groups included in the analysis target region.

FIG. 9 is a histogram illustrating the directions of the normal vectors of the feature points converted to the polar coordinates system in the process of S105. The histogram illustrated in FIG. 9 is also referred to as a SHOT descriptor.

The coordinate system conversion unit 25 can indicate a shape around the feature points, by describing a start point of each of the normal vectors of the feature points calculated in the process of S103 as an origin, and describing an end point of each of the normal vectors of the feature points as a spherically arranged histogram.

Next, the crown position information estimation unit 26 specifies the crown position information indicating the position of the tooth raw of the tooth corresponding to the crown, from the distribution in the direction of the normal vector of each of the feature points converted to the local coordinate system in the process of S105 (S106). In other words, the crown position information estimation unit 26 refers to the storage unit storing the distribution information on the direction of the unit normal vector corresponding to each point of the point groups in the local coordinate system in association with the type of the tooth, and estimates the type of the tooth corresponding to the obtained distribution as the type of the tooth in the analysis target region. As an example, the position of the tooth row of a tooth corresponds to a number indicated by the notation of the he FDI (Federation dentaire internationale) indicating the position of the tooth having the crown in the tooth row.

The crown position information estimation unit 26 estimates the crown position information indicating the position of the crown from the distribution in the direction of the normal vector of each of the feature points by machine learning. In other words, when vector data of many numerical values is obtained and there is a pattern in the obtained vector data, the crown position information estimation unit 26 learns the pattern, and estimates the number indicated by FDI notation based on the learned pattern.

The crown position information estimation unit 26 which detects and specifies the feature points belonging to the crown portion of the number indicated by the FDI notation from the tooth type scan data is prepared by the following procedures (i) to (iii) for example:

(i) From thousands of pieces of tooth type scan data, a two-dimensional histogram at a center position of the crown of the number indicated by FDI notation is acquired.
(ii) The crown position information estimation unit is caused to learn a correspondence between the number indicated by the FDI notation and the two-dimensional histogram.
(iii) It is confirmed whether the crown position information estimation unit 26 that has learns the correspondence in procedure (ii) has a predetermined detection performance.

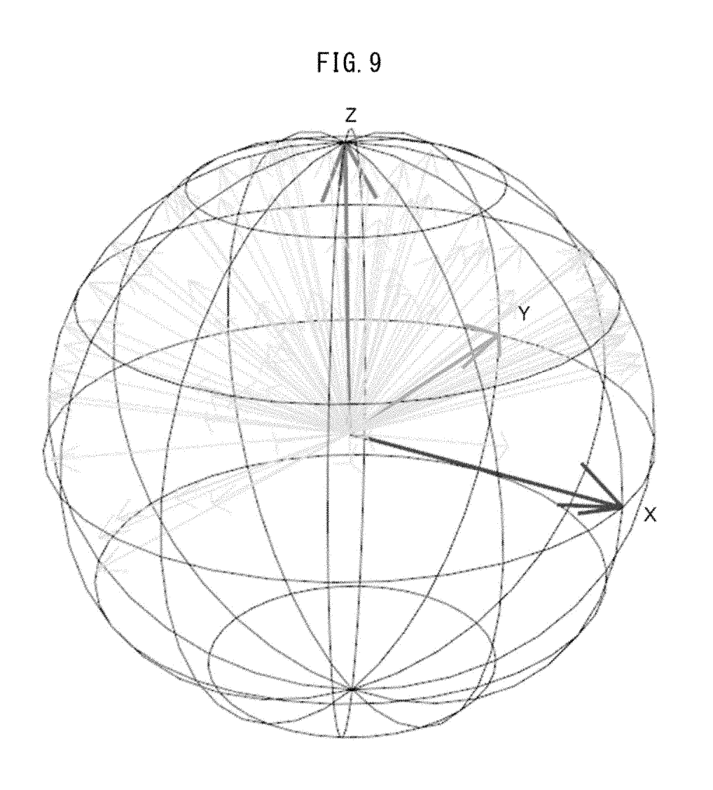

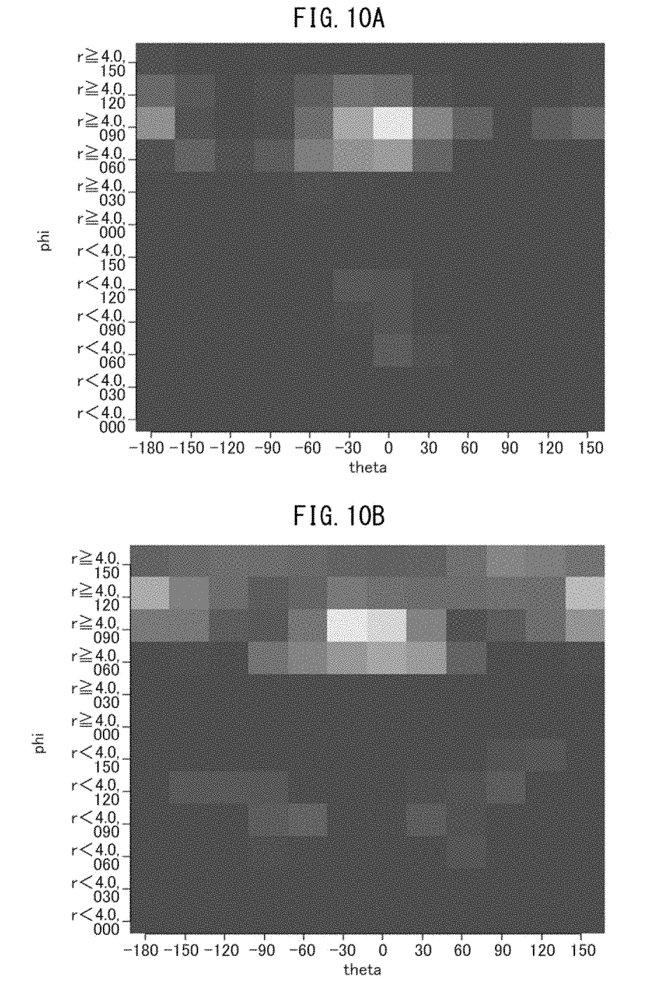

FIG. 10A is a view illustrating an example of the two-dimensional histogram, and FIG. 10B is a view illustrating another example of the two-dimensional histogram. In FIGS. 10A and 10B, the horizontal axis and the vertical axis indicate the deflection angles θ and φ of the polar coordinate system of the feature points converted in the process of S105.

FIG. 10A illustrates an example of the two-dimensional histogram corresponding to the number 11 indicated by the FDI notation, and FIG. 10B illustrates an example of the two-dimensional histogram corresponding to the number 14 indicated by the FDI notation.

Then, the crown position information output unit 27 outputs a crown position information signal indicating the crown position information specified in the process of S106 (S107).

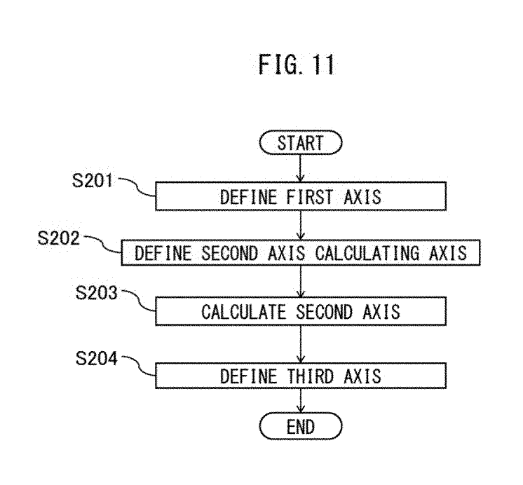

FIG. 11 is a flowchart illustrating more detailed processing than the process of S104.

First, the first axis definition unit 31 defines the X axis which is a first axis in a direction in which the calculated variance in the direction of the normal vector becomes maximum (S201).

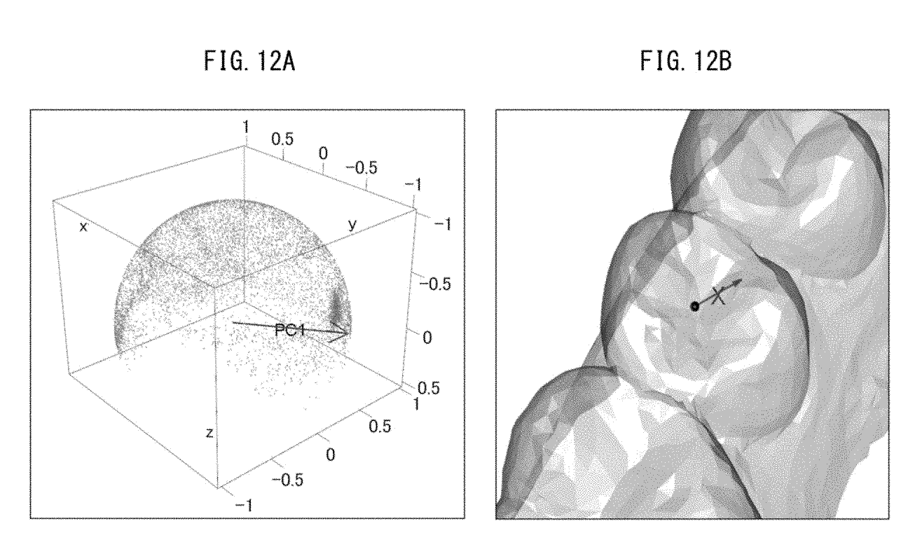

FIG. 12A is a view illustrating an example of the X axis defined in the SHOT descriptor, and FIG. 12B is a view illustrating an example of the X axis defined for the crown.

In the example illustrated in FIG. 12A, there are many normal vectors in both the extending direction of the X-axis PC 1 and the direction opposite to the extending direction of the X-axis PC 1, and therefore the extending direction of the X-axis PC 1 is the direction in which the variance in the direction of the normal vector becomes maximum.

Next, the second axis calculating axis definition unit 32 defines a second axis calculating axis N used for calculating the second axis in a direction in which the calculated variance in the direction of the normal vectors becomes minimum (S202). The second axis calculating axis definition unit 32 defines the second axis calculating axis N in the direction in which the calculated variance in the direction of the normal vectors becomes minimum, i.e., in a direction in which the directions of the normal vectors are averaged. The second axis calculating axis N is an axis used for determining the direction of the second axis, i.e., the Y axis.

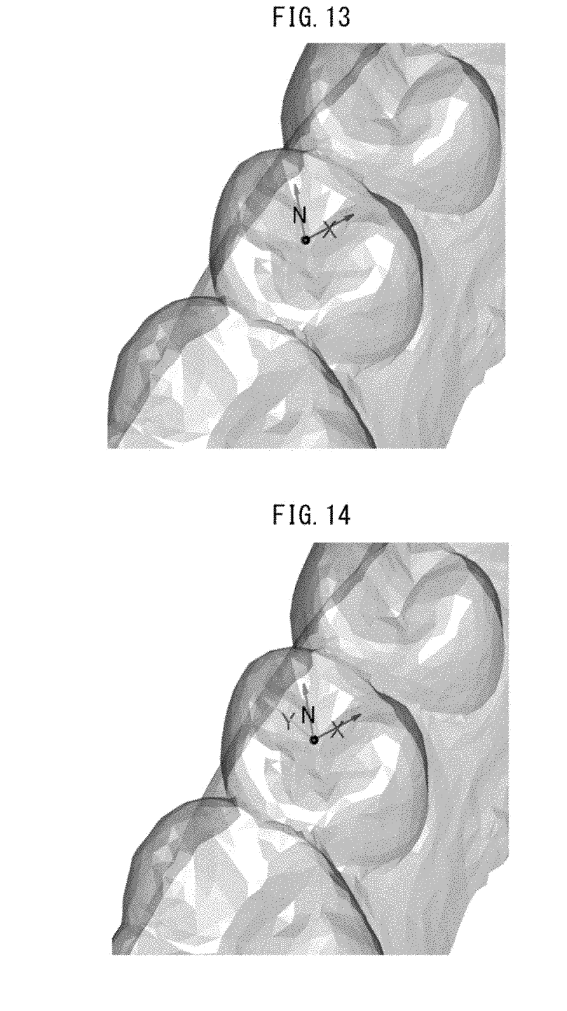

FIG. 13 is a view illustrating an example of the X axis and the second axis calculating axis N defined for the crown.

Since the second axis calculating axis N extends in a direction in which the calculated variance in the direction of the normal vectors becomes minimum, the extending direction of the X axis and the extending direction of the second axis calculating axis N are not always orthogonal.

Next, the second axis calculation unit 33 calculates the second axis, i.e., the Y axis, from an outer product of the X axis and the second axis calculating axis N (S203). The second axis calculation unit 33 calculates a direction which is orthogonal to the X axis and is also orthogonal to the second axis calculating axis N, as the Y axis direction.

FIG. 14 is a view illustrating an example of the X axis, the second axis calculating axis N and the Y axis defined for the crown. The Y axis extends in a direction which is orthogonal to the X axis and is also orthogonal to the second axis calculating axis N.

Then, a third axis definition unit 34 defines the Z axis which is a third axis in a direction orthogonal to both the X axis and the Y axis (S204).

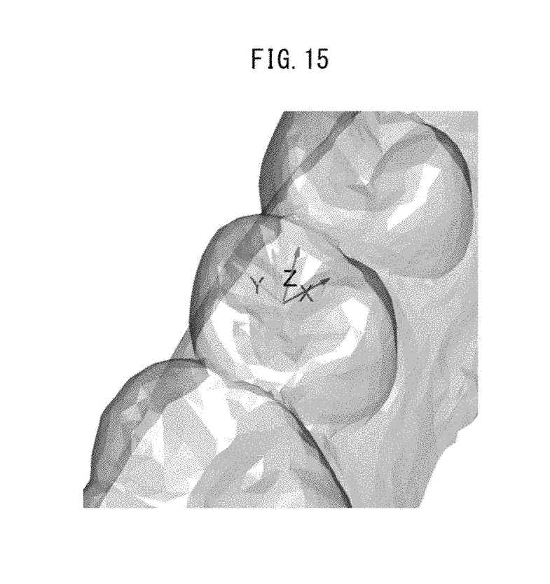

FIG. 15 is a view illustrating an example of the X axis, the second axis calculating axis N, the Y axis and the Z axis defined for the crown. The Z axis extends in a direction which is orthogonal to the X axis and is also orthogonal to the Y axis.

In the process of S104, in the calculation of the local coordinate system, a first axis where the normal vectors variance of the extracted point groups included in the extracted analysis target region becomes maximum, a second axis where the variance becomes minimum, and a third axis having a predetermined relationship with the first axis and the second axis, are set as a coordinate system. Here, the first axis is the axis where the unit normal vectors variance of the extracted point groups included in the analysis target region becomes maximum, and the second axis is the axis where the unit normal vectors variance of the extracted point groups included in the analysis target region becomes minimum. Further, the predetermined relationship is an orthogonal relationship or a predetermined non-orthogonal relationship.

### (Function and Effect of the Crown Position Judgment Device According to the Embodiment)

By using the distribution in the direction of the normal vector of each of the feature points, the crown position judgment device 1 is capable of estimating the position of the tooth raw of the tooth corresponding to the crown corresponding to the shape of the crown data, with no need to designate the point on the surface of the tooth row by a user.

Further, the crown position judgment device 1 is capable of suppressing a calculation amount needed for judging the crown position, by sampling the vertices included in the analysis target region of the tooth type scan data and extracting the feature points.

Further, according to the tooth axis estimation device 1, the direction of the normal vector of the vertex is calculated by weighting the directions of the normal vectors of the polygons including the vertex according to the areas of the polygons, and therefore the direction of the normal vector is calculated in consideration of the areas of the polygons including the vertex.

Further, when the local coordinate system used for creating the SHOT descriptor is defined, the tooth axis estimation device 1 defines the second axis calculating axis used for calculating the second axis in the direction in which the variance in the direction of the normal vectors becomes minimum, and calculates the second axis from the outer product of the first axis and the second axis calculating axis. By using the second axis calculating axis when the second axis is calculated, the SHOT descriptor can be created with high reproducibility.

All examples and conditional language provided herein are intended for pedagogical purposes of aiding the reader in understanding the invention and the concepts contributed by the inventor to furthering the art, and are to be construed as limitations to such specifically recited examples and conditions, nor does the organization of such examples in the specification relate to a illustrating of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a tooth type judgement program that causes a computer to execute a process comprising:
extracting a plurality of points from a inputted three-dimensional profile data, the plurality of points indicating a surface of the three-dimensional profile data;
extracting a point group included in any of an analysis target regions of the plurality of points;
calculating a local coordinate system based on a normal vectors variance, the normal vectors variance being based on each normal vector associated with each point of the point group;
obtaining a distribution in the local coordinate system, the distribution regarding directions of each unit normal vector associated with each point of the point group; and
referring to a storage unit that stores a plurality of distribution information in association with tooth types respectively, and specifying a tooth type corresponding to the obtained distribution as a tooth in the analysis target region.

2. The tooth type judgment program according to claim 1, wherein in the calculation of the local coordinate system, a coordinate system is formed by a first axis where a normal vectors variance of the extracted point groups included in the analysis target region becomes maximum, a second axis where the variance becomes minimum, and a third axis having a predetermined relationship with the first axis and the second axis.

3. The tooth type judgment program according to claim 2, wherein the first axis is the axis where a unit normal vectors variance of the extracted point groups included in the analysis target region becomes maximum, and the second axis is the axis where the unit normal vectors variance of the extracted point groups included in the analysis target region becomes minimum.

4. The tooth type judgment program according to claim 1, wherein the analysis target region is set in a region within a predetermined range from a target area for specifying a tooth type.

5. The tooth type judgment program according to claim 2, wherein the predetermined relationship is an orthogonal relationship or a predetermined non-orthogonal relationship.

6. A tooth type judgment method, comprising:
extracting a plurality of points from a inputted three-dimensional profile data, the plurality of points indicating a surface of the three-dimensional profile data;
extracting a point group included in any of an analysis target regions of the plurality of points;
calculating a local coordinate system based on a normal vectors variance, the normal vectors variance being based on each normal vector associated with each point of the point group;
obtaining a distribution in the local coordinate system, the distribution regarding directions of each unit normal vector associated with each point of the point group; and
referring to a storage unit that stores a plurality of distribution information in association with tooth types respectively, and specifying a tooth type corresponding to the obtained distribution as a tooth in the analysis target region.

7. A crown position judgment device, comprising:
a first extraction unit that extracts a plurality of points from a inputted three-dimensional profile data, the plurality of points indicating a surface of the three-dimensional profile data;
a second extraction unit that extracts a point group included in an analysis target region of the plurality of points;
a local coordinate axis definition unit that calculates a local coordinate system based on a normal vectors variance, the normal vectors variance being based on each normal vector associated with each point of the point group;
a coordinate system conversion unit that obtains a distribution in the local coordinate system, the distribution regarding directions of each unit normal vector associated with each point of the point group; and
a crown position information estimation unit that refers to a storage unit that stores a plurality of distribution information in association with tooth types respectively, and specifies a tooth type corresponding to the obtained distribution as a tooth in the analysis target region.

8. A non-transitory computer-readable recording medium having stored therein a tooth type judgment program that causes a computer to execute a process comprising:
extracting three-dimensional point groups having normal vectors indicating a surface of three-dimensional profile data, from the inputted three-dimensional profile data;
extracting point groups included in any of an analysis target regions of the extracted three-dimensional point groups having normal vectors;
calculating a local coordinate system, based on a normal vectors variance of the extracted point groups included in the analysis target region;
obtaining a unit normal vector distribution in the local coordinate system, corresponding to each point of the point groups included in the analysis target region; and
referring to a storage unit that stores distribution information regarding the unit normal vector direction in the local coordinate system, corresponding to each point of the point groups, in association with a tooth type, and estimating the tooth type corresponding to the obtained distribution as the tooth type in the analysis target region,
wherein calculation of the local coordinate system further comprises:
defining a first axis in a direction in which the calculated normal vector direction variance becomes maximum;
defining a second axis calculating axis used for calculating a second axis in a direction in which the calculated normal vector direction variance becomes minimum;
calculating the second axis from an outer product of the first axis and the second axis calculating axis; and
defining a third axis in a direction orthogonal to both the first axis and the second axis.
